(19) United States
(12) Patent Application Publication
(10) Pub. No.: US 2003/0200320 A1
(43) Pub. Date: Oct. 23, 2003

(54) Support roaming user in lotus notes environment

(75) Inventors: Ji-Wei Lin, Hsinchu (TW); Feng-Kuang Sung, Hsinchu (TW)

Correspondence Address: STEPHEN B. ACKERMAN, 25 DAVIS AVENUE,, POUGHKEEPSIE, NY, 12603, US

(73) Assignee: Taiwan Semiconductor Manufacturing Co.

(21) Appl. No.: 10/417,308

(22) Filed: Apr. 16, 2003

(30) Foreign Application Priority Data
Apr. 17, 2002 (CN) 91107869

(51) Int. Cl. G06F 15/16

(52) U.S. Cl. 709/228

(57) ABSTRACT

This invention provides a method and a computer program for supporting a roaming user in the Lotus Notes environment. This invention also provides a method and a computer program for storing three personal user files on all applicable servers within the user's computer network organization. The objectives of this invention are achieved by a method for supporting roaming users in the Lotus Notes environment. The method includes storing a global informative file, which contains the locations of all file servers, which store valid users' personal files.

### BACKGROUND OF THE INVENTION

1. Field of the Invention

This invention relates to a method and a computer program for supporting a roaming user in the Lotus Notes environment.

More particularly this invention relates to storing three personal user files on all applicable servers within the user's computer network organization.

2. Description of Related Art

Very often, in large organizations, a user needs to log into Lotus Notes from several different client PCs. Typically, in the prior art, a user would be required to copy the latest version of three key personal Lotus Notes files onto a floppy disk, zip disk or a writeable CD. This removeable media must be carried by the user to each remote PC used. These three personal files would be needed for the user to logon to Lotus Notes from a remote PC. This is the prior art method of roaming.

U.S. Pat. No. 6,012,085 (Yohe, et al.) “Apparatus and Method for Increased Data Access in a Network File Object Oriented Caching System” describes an apparatus and a method for increased data access using a file/object server computer.

U.S. Pat. No. 6,182,117 B1 (Christie, et al.) “Method and Apparatus for Workgroup Information Replication” shows a method of using an existing store-and-forward messaging network such as an electronic mail system to replicate data between computer sites.

U.S. Pat. No. 6,343,297 B1 (D'Anjou, et al.) “Methods, Systems, and Computer Program Products for Providing Document Management for Software Development Systems” shows how a document management system can be Incorporated with a software management system and a control library.

U.S. Pat. No. 6,212,553 (Lee, et al.) “Method for Sending and Receiving Flags and Associated Data in E-Mail Transmissions” describes a system and method for automatically checking recipients' names, providing message flags, providing custom forms, and providing an autoresponse feature.

### BRIEF SUMMARY OF THE INVENTION

It is the objective of this invention to provide a method and a computer program for supporting a roaming user in the Lotus Notes environment.

It is further an objective of this invention to provide a method and a computer program for storing three personal user files on all applicable servers within the user's computer network organization.

The objectives of this invention are achieved by a method for supporting roaming users in the Lotus Notes environment. The method includes storing a global informative file, which contains the locations of all file servers, which store valid users' personal files. It also includes a means for storing said users' personal files on individual client PCs, which are used or to be used by said user, placing a user's mail on a user's name server, and balancing file server loading. The method of supporting roaming users in the Lotus Notes environment of Involves retrieving individual personal files as needed, checking Lotus Notes version on a client PC, and upgrading said Lotus Notes version if it is not the latest version required. The stored personal Lotus Notes files include desktop settings, personal address book and certification ID. The applicable file servers contain stored information about all file servers that a given user would likely use. Valid users include all users authorized to use an organization's computer networks and servers. The balancing of file server loading is done by a specialized file server. The retrieval of a user's Lotus Location files is from a current local client PC where the user is working. The retrieval of the user's Lotus location files points to latest server with personal Lotus Location files successfully located. The retrieval of the user's Lotus personal (location) files yields incorrect file versions, all file servers are tested sequentially in order to locate said correct version of said user's personal files. If the correct version is not found, an error message indicates unsuccessful location of said user's personal files is posted. If an initial click of Lotus Notes results in a warning that a given local PC version of Lotus Notes is not current, an upgrade process occurs. The user's four personal location files include an ID file location, which contains the location of said ID or identification security file. The user's four personal location files include a desktop location file, which contains the location of said user's desktop. The user's four personal location files include a personal address book location file, which contains the location of the user's personal Lotus Notes address book. The user's four personal location files include a file, which contains the latest server, which contains said 4 personal location files successfully in a roaming process of this invention.

### BRIEF DESCRIPTION OF THE DRAWINGS

FIG. 1 shows the primary flowchart illustrating the main embodiment of the method of this invention.

FIG. 2 shows a sub-flowchart of the method of this invention.

### DETAILED DESCRIPTION OF THE INVENTION

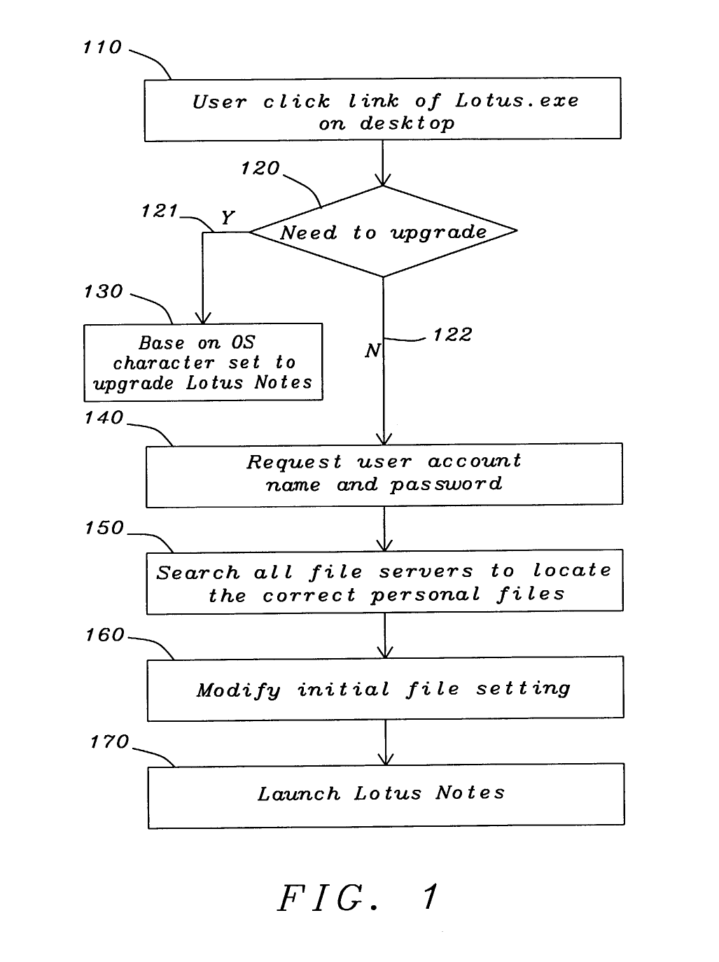

FIG. 1 shows the main flowchart, which describes the method of this invention. The objective of this flowchart is to allow a valid user to access the correct Lotus Notes version anyplace within his valid organization and anytime within the limits of the system of the user's organization.

The FIG. 1 flow begins with the user clicking on the Lotus Notes icon 110 on the desktop. Next the program flow checks if the local client PC has the latest or correct version of Lotus Notes 120. The decision block 120 asks if there is a need to upgrade Lotus Notes. If the answer is yes 121, Lotus Notes is upgraded, 130. The client PC operating system version is checked 130 to determine the character sert or foreign language version required for the Lotus Notes upgrade installation. If the answer to the upgrade question 120 is No 122, the program flow requests that the user submit his user account name and password 140. Next, the methodology searches all file servers within the user's organization to locate the correct personal files for the user 150. The user personal files required and the certification identification file, the desktop setting file, and the personal address book. Next, the program modifies the initial file setting in the local client PC 160. The Notes ini file is modified to include the location of user's specific information. For example, the Notes ini file is updated to include the location of the user's certification ID file, the location of the user's desktop settings file, the location of the user's personal address book, and the latest server where the given user's correct personal files were found. Finally, Lotus Notes is launched 170 on the client PC where the user is presently located.

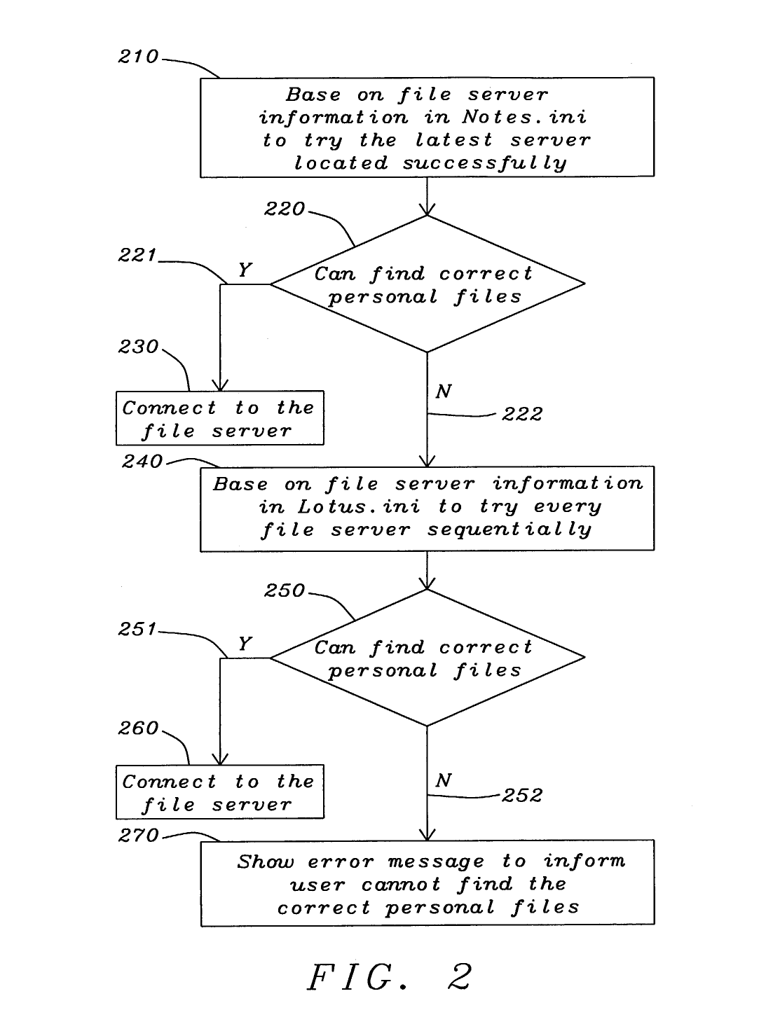

FIG. 2 shows a sub-flow of the method. This sub-flow occurs within the action block 150 of FIG. 1. The purpose of the sub-flow in FIG. 2 is to locate the user's personal Lotus files.

First, based on the file server information contained in the Notes. ini file on the client PC where the user is trying to Log-on to Lotus Notes, the flow 210 is searching the server mentioned as the latest server located successfully. Next, the decision block 220, asks if the logic could find the correct personal files. If the answer is Yes 221, the program flow connects and communicates with the given file server. The Lotus. ini file is an initial file in each server. This file contains the locations of all file servers, which store users' personal files. If the answer is No 222, based on the file server information in the Lotus. ini file, the program flow 240 will try every file server sequentially. This objective of this sequential search is to locate the user's correct personal Lotus files.

Next, another decision block 250 asks if the correct personal Lotus files can be found during the sequential search of the servers. If the answer is YES 251, the program flow at the current user's client PC connects & communicates with the successful server 260. If the answer is No 252, the program flow 270 will show an error message on the display of the current user's client PC to inform the user that his correct Lotus Notes personal files cannot be found.

This invention provides a mechanism for the network login script to distribute the link to the computer program which implements the method of this invention to every desktop of every PC in the user's organization. The latest implementation of the program of this invention can be distributed efficiently via the local and wide area networks to all client PCs in a given organization.

There are several advantages of this invention. First, it provides a method and a computer program for retrieving a user's Lotus Notes personal files in file servers and to use these personal files to launch Lotus Notes anywhere and anytime. Second, the invention provides for Lotus Notes software distribution including performing a Lotus Notes version check for the user. The invention provides for an automatic Lotus Notes upgrade if it is required. Finally, the invention provides a mechanism for the network login script to distribute the link to the computer program which implements the method of this invention to every desktop of every PC in the user's organization.

While this invention has been particularly shown and described with Reference to the preferred embodiments thereof, it will be understood by those Skilled in the art that various changes in form and details may be made without Departing from the spirit and scope of this invention.

What is claimed is:

1. A method for supporting roaming users in the Lotus Notes environment comprising the steps of:
storing a global information file, which contains the locations of all file servers, which store valid users' personal files,
storing said users' personal files on individual client PCs, which are used or to be used by said user, placing a user's mail on a user's name server, and balancing file server loading.

2. The method of supporting roaming users in the Lotus Notes environment of claim 1 further comprising the steps of:
retrieving individual personal files as needed,
checking Lotus Notes version on a client PC, and
upgrading said Lotus Notes version if it is not the latest version required.

3. The method of supporting roaming users in the Lotus Notes environment of claim 1 wherein said stored personal Lotus Notes files include desktop settings, personal address book and certification ID.

4. The method of supporting roaming users in the Lotus Notes environment of claim 1 wherein said applicable file servers contains stored information about all file servers that a given user would likely use.

5. The method of supporting roaming users in the Lotus Notes environment of claim 1 wherein said valid users include all users authorized to use an organization's computer networks and servers.

6. The method of supporting roaming users in the Lotus Notes environment of claim 1 wherein said balancing of file server loading is done by a specialized file server.

7. The method of supporting roaming users in the Lotus Notes environment of claim 1 wherein said retrieval of a user's Lotus Location files is from a current local client PC where said user is working.

8. The method of supporting roaming users in the Lotus Notes environment of claim 1 wherein retrieval of said user's Lotus location files points to latest server with personal Lotus location files successfully located.

9. The method of supporting roaming users in the Lotus Notes environment of claim 1 wherein said retrieval of said user's Lotus personal (location) files yields incorrect file versions, all file servers are tested sequentially in order to locate said correct version of said user's personal files.

10. The method of supporting roaming users in the Lotus Notes environment of claim 1 wherein said correct version is not forward, an error message indicates unsuccessful location of said user's personal files is posted.

11. The method of supporting roaming users in the Lotus Notes environment of claim 1 wherein if an initial click of Lotus Notes results in a warning that a given local PC version of Lotus Notes is not current, an upgrade process occurs.

12. The method of supporting roaming users in the Lotus Notes environment of claim 1 wherein said user's four personal location files include an ID file location, which contains the location of said ID or identification security file.

13. The method of supporting roaming users in the Lotus Notes environment of claim 1 wherein said user's four personal location files include a desktop location file, which contains the location of said user's desktop.

14. The method of supporting roaming users in the Lotus Notes environment of claim 1 wherein said user's four personal location files include a personal address book location file, which contains the location of said user's personal Lotus Notes address book.

15. The method of supporting roaming users in the Lotus Notes environment of of claim 1 wherein said user's four personal location files include a file, which contains the latest server, which contains said 4 personal location files successfully in a roaming process of this invention.

16. A program retention device containing program instruction code executable on at least one networked computing device for supporting roaming users in the Lotus Notes environment comprising:
a means for storing a global information file, which contains the locations of all file servers, which store valid users' personal files,
a means for storing said users' personal files on individual client PCs, which are used or to be used by said user,
a means for placing a user's mail on a user's name server, and
a means for balancing file server loading.

17. The program retention device containing program instruction code executable on at least one networked computing device for supporting roaming users in the Lotus Notes environment of claim 16 further comprising:
a means for retrieving individual personal files as needed,
a means for checking Lotus Notes version on a client PC, and
a means for upgrading said Lotus Notes version if it is not the latest version required.

18. The program retention device containing program instruction code executable on at least one networked computing device for supporting roaming users in the Lotus Notes environment of claim 16 wherein said stored personal Lotus Notes files include desktop settings, personal address book and certification ID.

19. The program retention device containing program instruction code executable on at least one networked computing device for supporting roaming users in the Lotus Notes environment of claim 16 wherein said applicable file servers contains stored information about all file servers that a given user would likely use.

20. The program retention device containing program instruction code executable on at least one networked computing device for supporting roaming users in the Lotus Notes environment of claim 16 wherein said valid users include all users authorized to use an organization's computer networks and servers.

21. The program retention device containing program instruction code executable on at least one networked computing device for supporting roaming users in the Lotus Notes environment of claim 16 wherein said balancing of file server loading is done by a specialized file server.

22. The program retention device containing program instruction code executable on at least one networked computing device for supporting roaming users in the Lotus Notes environment of claim 16 wherein said retrieval of a user's Lotus location files is from a current local client PC where said user is working.

23. The program retention device containing program instruction code executable on at least one networked computing device for supporting roaming users in the Lotus Notes environment of claim 16 wherein retrieval of said user's Lotus location files points to latest server with personal Lotus location files successfully located.

24. The program retention device containing program instruction code executable on at least one networked computing device for supporting roaming users in the Lotus Notes environment of claim 16 wherein said retrieval of said user's Lotus personal (location) files yields incorrect file versions, all file servers are tested sequentially in order to locate said correct version of said user's personal files.

25. The program retention device containing program instruction code executable on at least one networked computing device for supporting roaming users in the Lotus Notes environment of claim 16 wherein said correct version is not forward, an error message indicates unsuccessful location of said user's personal files is posted.

26. The program retention device containing program instruction code executable on at least one networked computing device for supporting roaming users in the Lotus Notes environment of claim 16 wherein if an initial click of Lotus Notes results in a warning that a given local PC version of Lotus Notes is not current, an upgrade process occurs.

27. The program retention device containing program instruction code executable on at least one networked computing device for of supporting roaming users in the Lotus Notes environment of claim 16 wherein said user's four personal location files include an ID file location, which contains the location of said ID or identification security file.

28. The program retention device containing program instruction code executable on at least one networked computing device for supporting roaming users in the Lotus Notes environment of claim 16 wherein said user's four personal location files include a desktop location file, which contains the location of said user's desktop.

29. The program retention device containing program instruction code executable on at least one networked computing device for supporting roaming users in the Lotus Notes environment of claim 16 wherein said user's four personal location files include a personal address book location file, which contains the location of said user's personal Lotus Notes address book.

30. The program retention device containing program instruction code executable on at least one networked computing device for supporting roaming users in the Lotus Notes environment of claim 16 wherein said user's four personal location files include a file, which contains the latest server, which contains said 4 personal location files successfully in a roaming process of this invention.
